(19) United States
(12) Patent Application Publication
(10) Pub. No.: US 2009/0056304 A1
(43) Pub. Date: Mar. 5, 2009

(54) Solar energy augmented jet aircraft

(76) Inventors: Randall Paul Joseph Ethier, Burke, VA (US); Jason How-Ring Ethier, Burke, VA (US)

Correspondence Address: Randall Paul Joseph Ethier, 5007 Prince Caspian Lane, Burke, VA, 22015, US

(21) Appl. No.: 11/899,161

(22) Filed: Sep. 5, 2007

(51) Int. Cl. B64D 27/16; B64D 27/24

(52) U.S. Cl. 60/203.1; 244/73 R

(57) ABSTRACT

A solar energy augmented jet aircraft uses solar energy as the energy source for dielectric heating of a jet engine exhaust gas stream thereby increasing thrust.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

None.

### BACKGROUND OF THE INVENTION

The present invention relates to jet engines, solar energy, microwaves, and the nature of dipole electric molecules.

Many aircraft today use jet engines to provide thrust for propulsion. Jet engines take in and compress air which is then injected with a fuel which is then burned with oxygen to produce a hot gas that is expelled at high speed thereby producing thrust which moves the aircraft through the air in accordance with Newton's 3^{rd} law of motion.

Some solar energy propelled aircraft have been built. Solar cells provide electrical power which in turn runs one or more electric motors to turn one or more propellers.

Microwave ovens use electricity to heat foods that contain water. Molecules that are electric dipoles will absorb energy from microwave radiation. Water forms dipole molecules. Although such dipoles have an overall neutral charge, they have a positive charge at one end and a negative charge at the other end. When exposed to microwaves these dipole molecules rotate as they try to align with the alternating electric field induced by the microwaves. This added rotation of the molecules increases the kinetic energy of the molecules. In this way a microwave oven heats up food that contains water molecules.

Jet engine exhaust consists in part of electric dipole molecules, such as water vapor.

Photovoltaic cells convert sunlight into electricity for use by electrical machines and devices.

Today jet propulsion does not take advantage of available radiant solar energy.

### SUMMARY OF THE INVENTION

When a jet engine aircraft operates while exposed to the radiant energy of the sun, this energy can be converted into electricity. In turn this electricity can be used to power an electromagnetic radiation emitter that performs dielectric heating of the electric dipoles in the jet engine exhaust gas stream thereby increasing the jet engine thrust.

### BRIEF DESCRIPTION OF THE DRAWING

No diagram is provided as it is unnecessary.

### DETAILED DESCRIPTION OF THE INVENTION

Photovoltaic cells are attached to surface areas of a jet aircraft that are exposed to sunlight.

Note that as the aircraft's altitude increases, the electrical output from these photovoltaic cells increases. This is due to the thinning of the atmosphere which allows more of the sun's radiant energy to reach the aircraft's photovoltaic cells.

A significant portion of the molecules in a jet engine's exhaust are electric dipoles. Water vapor is one such example. In the special case of a jet engine burning hydrogen with oxygen, all of the jet engine's exhaust gas stream is water vapor.

One or more electromagnetic emitters are powered by the electricity from the photovoltaic cells. Somewhere between the jet engine combustion chamber and the jet engine exhaust nozzle, these emitters radiate radiant energy to the jet engine exhaust gas stream. This could occur for instance in what might otherwise be the jet engine afterburner chamber. The emitters bring about dielectric heating of the electric dipole molecules in the jet engine gas stream. Dielectric heating is the phenomenon in which electromagnetic radiation heats dipoles by causing or increasing dipole rotation. This added rotation is increased heat thereby increasing the exit velocity of the jet engine exhaust gas stream which equates to more thrust.

While one embodiment of the invention has been specified, it will be apparent to those of ordinary skill in the art that many more embodiments and implementations are possible within the scope of the invention. Accordingly this invention is not to be restricted except in light of the attached claims and their equivalents.

1. An aircraft comprising:
A) at least one jet engine for producing thrust
B) photovoltaic cells that convert sunlight into electricity
C) at least one electromagnetic radiation emitter that converts electricity into electromagnetic radiation aimed either within the jet engine combustion chamber or anywhere within the exhaust gas stream prior to the jet engine exit nozzle such that dielectric heating of the electric dipoles of the jet engine exhaust stream occurs
thereby leveraging solar energy to increase the exit velocity of jet engine exhaust which equates to more thrust.
